(19) United States
(12) Patent Application Publication
(10) Pub. No.: US 2023/0377005 A1
(43) Pub. Date: Nov. 23, 2023

(54) Packaging Evaluation Using NLP For Customer Reviews

(71) Applicant: Board of Trustees of Michigan State University, East Lansing, MI (US)

(72) Inventor: Euihark LEE, Okemos, MI (US)

(73) Assignee: Board of Trustees of Michigan State University, East Lansing, MI (US)

(21) Appl. No.: 18/201,006

(22) Filed: May 23, 2023

Related U.S. Application Data
(60) Provisional application No. 63/344,669, filed on May 23, 2022.

(51) Int. Cl. G06Q 30/0282; G06F 40/284; G06F 40/289

(52) U.S. Cl. CPC G06Q 30/0282; G06F 40/284; G06F 40/289

(57) ABSTRACT

A method of evaluating a package durability includes extracting, using a package evaluation system, a plurality of customer reviews for a specific product from a user-identified website. Each customer review includes data that is used to express a customer's experience with the specific product. The method includes identifying one or more packaging related reviews based on a packaging list profile and the plurality of customer reviews; predicting whether each of the one or more packaging related reviews is a negative review or a positive review; and determining whether the package meets an assurance level based on a percentage of failure rate. The assurance level indicates whether the package provides an acceptable level of performance. The method includes providing a notification of a determination of whether the package meets the assurance level.

### CROSS-REFERENCE TO RELATED APPLICATIONS

This application is a U.S. patent application, which claims priority to and the benefit of U.S. Provisional Patent Application No. 63/344,669 filed on May 23, 2022. The entire disclosure of the above application is incorporated herein by reference.

### FIELD

The present disclosure relates to a method and system for evaluating package performance using customer reviews.

### BACKGROUND

This section provides background information related to the present disclosure which is not necessarily prior art.

The current and predicted growth of e-commerce has significantly impacted the packaging industry. Along with this significant increase in e-commerce growth, the shift from traditional retail to e-commerce package distribution has introduced new hazards and placed greater demands on protective packaging. Many such packaging distribution systems have four major challenges to consider: supply chain, weight of the material, product integrity, and safety and customization. In other words, a potentially longer supply chain calls for more robust packaging. Packages during the distribution process in e-commerce have three times more touch points compared to brick-and-mortar distribution. The weight of material directly affects the cost for the freight. Also, more weight not only increases the distribution cost but also the environmental impacts. Moreover, the package should be able to ensure product integrity and safety. Consumers expect to receive a product damage free, thus the packaging should save the product from impacts, moisture, and excess air. Last but not least, a package needs to convey a sense of customization during online shopping. Customers want an experience to remember the product because no salesperson is there to promote the product. All in all, the design of the package should be changed for the e-commerce. All of these challenges show the important role of packaging evolution in e-commerce.

The distribution network for e-commerce typically involves almost three times as many touch points as traditional retail, increasing the likelihood of damage during transportation. Consequently, various packaging evaluation tests have been developed to ensure the safety of product-package systems during transportation. These tests are categorized into field evaluation, laboratory evaluation, and numerical evaluation. Field evaluation involves subjecting packages to real-world transportation conditions, laboratory evaluation involves simulating transportation conditions in a controlled environment, and numerical evaluation relies on computer modeling and simulations to predict package performance.

These and other issues related to evaluating a package for a product in an e-commerce distribution system are discussed herein.

### SUMMARY

This section provides a general summary of the disclosure, and is not a comprehensive disclosure of its full scope or all of its features.

In one form, the present disclosure provides a method of evaluating a package durability includes extracting, using a package evaluation system, a plurality of customer reviews for a specific product from a user-identified website. Each customer review includes data that is used to express a customer's experience with the specific product. The method includes identifying, using the package evaluation system, one or more packaging related reviews based on a packaging list profile and the plurality of customer reviews; categorizing, using the package evaluation system, whether each of the one or more packaging related reviews is a negative review or a positive review; and determining, using the package evaluation system, whether the package meets an assurance level based on a percentage of failure rate associated with a plurality of negative reviews categorized. The assurance level indicates whether the package provides an acceptable level of performance. The method includes providing one or more results of the evaluation of the package based on the assurance level and the percentage of failure rate.

In one form, the identifying, using the package evaluation system, the one or more packaging reviews includes splitting, using a tokenization process of the packing evaluation system each customer review of the plurality of customer reviews into one or more text words. The one or more text words includes an individual word or a phrase having two or more words. The method includes determining, using a lemmatization process of the packaging evaluation system, a base form of each word in the one or more text words; and identifying, using the package evaluation system, one or more packaging related reviews based on a packaging list profile and the one or more text words.

In one form, categorizing, using the package evaluation system, whether reach of the one or more packaging related reviews includes classifying the one or more package related reviews as the positive review or the negative review using natural language processing.

In one form, extracting, using the package evaluation system, the one or more customer reviews includes retrieving the one or more customer reviews using a web scrapper of the package evaluation system.

In one form, the one or more customer reviews includes one or more text words describing the customer experience with the specific product and one or more customer uploaded images associated with the one or more text words.

In one form, the method includes identifying, using the packaging evaluation system, a number of negative reviews; identifying, using the packaging evaluation system, a number of positive reviews; determining, using the packaging evaluation system, a percentage of failure rate for the negative reviews based on a total number of package reviews; displaying a graphical image of the percentage of failure rate for the negative reviews.

In one form, the method includes extracting, using the package evaluation system using an embedded web scraper, the customer reviews from the website for the specific product based on a predetermined rating criteria; splitting, using a tokenization process of the packing evaluation system, each customer review into one or more text words, wherein the one or more text words includes an individual word or a phrase having two or more text words; ranking the one or more text words based on a frequency of occurrence; and generating the packing list profile based on one or more ranked text words. The packing list profile is a library of text words related to packaging.

In one form, a predetermined rating criteria includes a low rating of two or below.

In one form, the method includes receiving, using the packaging evaluation system, one or more packaging related terms from user interface device to modify the packing list profile.

In one form, the method includes determining that the package is acceptable, if the failure rate is lower than the assurance level; determining that the package is unacceptable and should be redesigned, if the failure rate is above the assurance level, the package for the product may need to be redesigned; and displaying an indicator providing whether the failure rate meets the assurance level.

In one form, the method includes identifying, using the packaging evaluation system, a customer identified-problem based a relationship between two frequently occurring text words found within the plurality of negative reviews categorized, wherein the two text words includes a first text word describing a package feature and a second text word that co-occurs in association with the first text word.

In one form, identifying, using the evaluation packaging system, one or more customer identified-problems associated with the package includes: identifying a list of frequently occurring text words used within the plurality of negative reviews categorized, wherein at least one text word of the list of frequently occurring text words identifies a packaging feature; identifying one or more relationships between a first text word of the list of frequently occurring list of text words and another frequently occurring text word of the list of text words associated with the first text word; and determining the one or more customer identified-problems based on the one or more identified relationships.

In one form, the method includes determining, using the evaluation packaging system, a number of occurrences for each identified relationship between each packaging feature of the list of frequently occurring packaging features and a frequently text word associated with a respective packaging feature.

In one form, the method includes pruning, one or more identified relationships between each packaging feature of the list of frequently occurring packaging features and a frequently text word associated with a respective packaging feature to reduce the number of identified relations below a predetermined threshold.

In one form, the present disclosure provides a packaging evaluation system includes a processor; and a non-transitory computer readable medium comprising instructions that are executable by the processor. The instructions comprise: extracting a plurality of customer reviews for a specific product from a user-identified website. Each customer review includes one or more text words that is used to express a customer's experience with the specific product. The instruction include identifying one or more packaging related reviews based on a packaging list profile and the plurality of customer reviews; categorizing, using natural language processing, whether each of the one or more packaging related reviews is a negative review or a positive review; determining a customer identified-problem based a relationship between two frequently occurring text words found within the plurality of negative reviews categorized. The two text words includes a first text word describing a package feature and a second text word that co-occurs in association with the first text word. The instructions include providing one or more results of an evaluation of the package based on the customer identified problem.

In one form, the one or more customer reviews further includes one or more text words describing the customer experience with the specific product and one or more customer uploaded images associated with the one or more text words.

In one form, the instructions include extracting, using a web scrapper, the customer reviews from the website for the specific product based on a predetermined low rating criteria; splitting, using a tokenization process of the packing evaluation system, each customer review into one or more text words. The one or more text words includes an individual word or a phrase having two or more words. The instructions includes ranking the one or more text words based on a frequency of occurrence; and generating the packing list profile based on one or more ranked text words, wherein the packing list profile is a library of words related to packaging.

In one form, identifying one or more customer identified-problems associated with the package includes identifying a list of frequently occurring text words used within the plurality of negative reviews categorized, wherein at least one text word of the list of frequently occurring text words identifies a packaging feature; identifying one or more relationships between a first text word of the list of frequently occurring list of text words and another frequently occurring text word of the list of text words associated with the first text word; and determining the one or more customer identified-problems based on the one or more identified relationships.

In one form, the instructions include determining a number of occurrences for each identified relationship between each packaging feature of the list of frequently occurring packaging features and a frequently text word associated with a respective packaging feature.

In one form, the instructions include pruning, one or more identified relationships between each packaging feature of the list of frequently occurring packaging features and a frequently text word associated with a respective packaging feature to reduce the number of identified relations below a predetermined threshold.

In one form, the present disclosure provides a method including scraping a plurality of customer reviews for a specific product from a user-identified website. Each customer review includes one or more text words that is used to express a customer's experience with the specific product. The method includes identifying one or more packaging related reviews based on a packaging list profile and the plurality of customer reviews; categorizing, using a natural language process, whether each of the one or more packaging related reviews is a negative review or a positive review; and identifying a customer identified-problem based a relationship between two frequently occurring text words found within the plurality of negative reviews categorized, wherein the two text words includes a first text word describing a package feature and a second text word that co-occurs in association with the first text word; and providing one or more results of an evaluation of the package based on the customer identified problem.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of a system for evaluating a package of a product in accordance with the teachings of the present disclosure;

FIG. 2 is an example packaging evaluation portal in accordance with the teachings of the present disclosure;

FIG. 3 is a flowchart of a method of evaluating a package in accordance with the teachings of the present disclosure;

FIG. 4 is a flowchart of a continued method of FIG. 3 in accordance with the teachings of the present disclosure;

FIG. 5 is a bar chart graph depicting a distribution of negative reviews of a first example case study in accordance with the present disclosure;

FIG. 6 is a chart graph providing an example of results for failure rate vs success rate in accordance with the teachings of the present disclosure;

FIG. 7 is a graph depicting a failure rate over time in accordance with the teachings of the present disclosure;

FIG. 8 is a graph of a word cloud in accordance with the teachings of the present disclosure;

FIG. 9 is a graphical illustration depicting a plurality of relationships between words based on support value; edges' weight shows support value, and vertices are frequent words in reviews in accordance with the teachings of the present disclosure;

FIG. 10 is a bar graph depicting packing failure rates of two different packages in accordance with the teachings of the present disclose;

FIG. 11 is a graphical representation of percentage of failure rates for a product in different brands in accordance with the teachings of the present disclosure;

FIG. 12 provides a graph that tracks the failure rate over time, and shows the percent of negative reviews in different months and years for the three TV brands in accordance with the teachings of the present disclosure; and

FIG. 13 is a word cloud graph depicting a frequency of package related words for an example package in accordance with the teachings of the present disclosure.

Corresponding reference numerals indicate corresponding parts throughout the several views of the drawings.

### DETAILED DESCRIPTION

Example embodiments will now be described more fully with reference to the accompanying drawings.

The present disclosure provides methods and systems for evaluating package performance using customer reviews by implementing natural language processing (NLP). In one form, the methods and systems of the present disclosure extracts customer reviews, using a package evaluation system, from an e-commerce website. The customer reviews may include text words and, optionally, one or more images associated with the text word. The methods and system filters out one or more package related reviews from among the extracted customer reviews, using a package profile. The method and system further includes categorizing, using the package evaluation system, the package related reviews customer reviews into positive and negative reviews and identifying a package failure rate based on the negative reviews and evaluating the package performance based on the package failure rate and an assurance level that indicates whether a package redesign is needed. Also, by using keyword clustering, a location of the packing problem is identified. Using the methods and system as provided herein, potential package concerns can be identified in the early stages.

In one form, the present disclosure provides a method and system to evaluate packaging performance from customer reviews by implementing natural language processing (NLP). To identify package failure, sentimental analysis (SA), a subset of NLP, is used to categorize reviews and sentences into positive, negative, and neutral. To enhance the efficiency of the NLP process, a Packaging list profile is introduced, which is a packaging related word library.

In some forms, the present disclosure presents an evaluation of packaging performance using customer reviews in the E-commerce domain. The failure rates are presented and used to compare the packaging functions of different products. Also, by using keyword clustering, the location of the packaging problem is identified. By using an NLP-based package evaluation method, package failure can be identified in the early stages, dramatically reducing packaging evaluation cost and time.

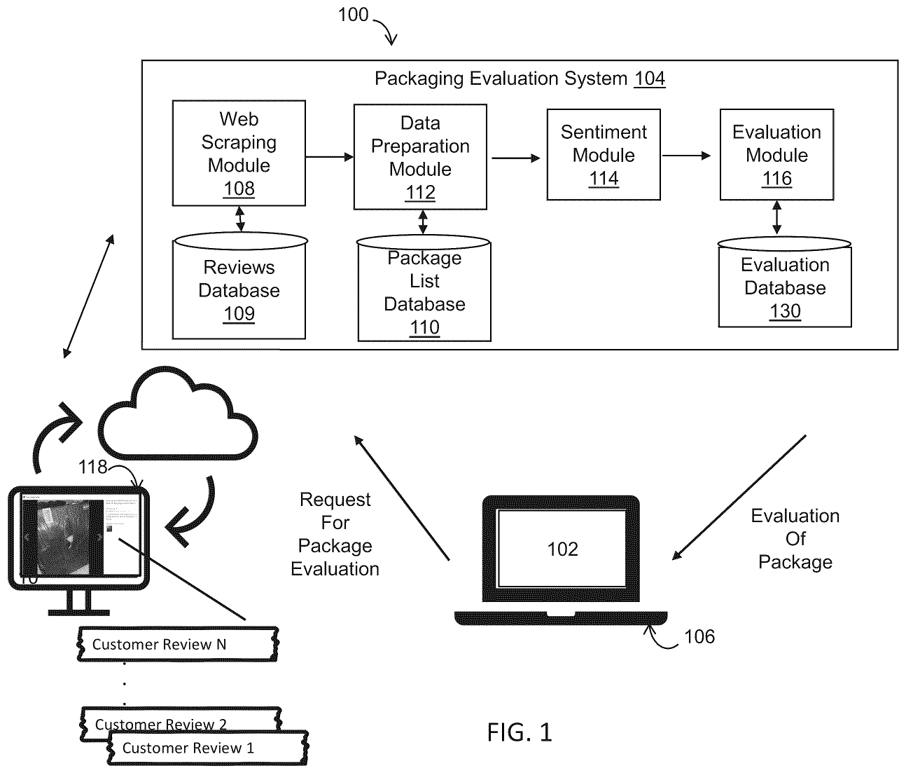

Referring to FIG. 1, an example system 100 is provided. In one form, the system 100 may be integrated into as a subsystem into one or more other existing packaging distribution or packaging design systems for evaluating a package. In one form, the system 100 includes a packaging evaluation (PE) portal 102 and a PE system 104. The PE portal 102 is a user interface to provide a user access to the PE system 104. In one form, as provided herein, the PE system 104 is configured to evaluate and determine whether a package meets an assurance level based on a percentage of failure rate. In one form, the PE system 104 is configured to communicate with a remote server (not shown) hosting an-ecommerce website having a webpage 118 associated with a product. The remote server may be a messaging device that brokers connection with the internet. As used herein “remote server” refers to any device associated with an e-commerce website, establishing internet connections between the website 118 and the packaging evaluation system 104, and sending and receiving messages with the PE system 104. The remote server may include one or more processor circuits configured to execute instructions stored in a non-transitory computer readable medium, such as a random-access memory (RAM) circuit and/or read-only memory (ROM) circuit.

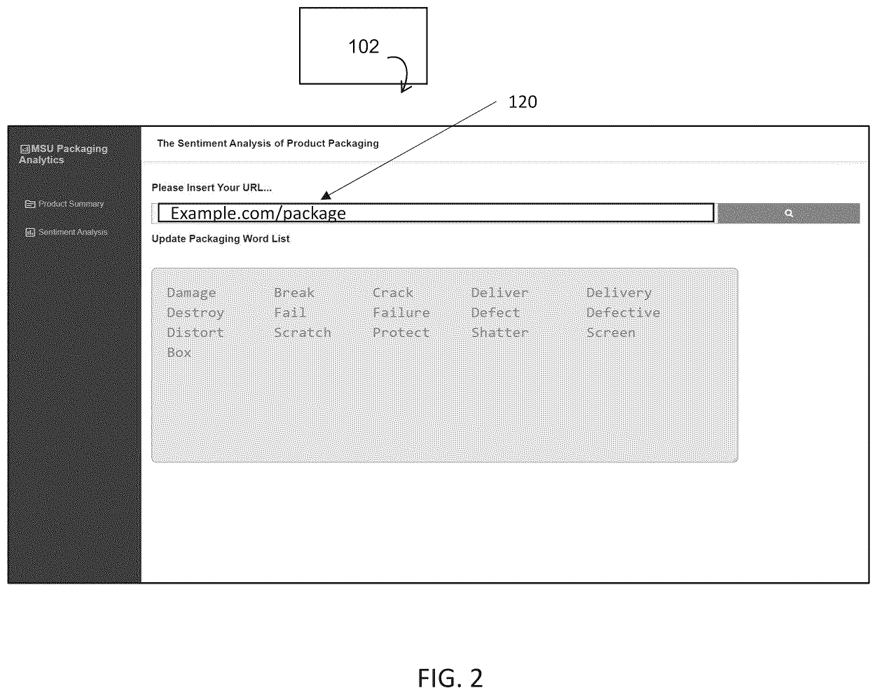

In one form, via the PE portal 102, the user provides at least one web address, such as a URL address and request an evaluation of a package for a specific product associated with the web address as shown FIG. 2. In one form, the PE portal 102 is accessible via a computing device 106 that is in communication with the PE system 104 via for example, the internet and/or a communication network. The computing device 106 may include a desktop computer, a laptop, a smartphone, a tablet computer, or the like.

Referring again to FIG. 1, the PE system 104 includes a web scraping module 108, a reviews database 109, a packaging list database 110, a data preparation module 112, a sentiment module 114, and an evaluation module 116. It is understood that the modules and the database (e.g., a repository, a cache, and/or the like) of the PE system 104 may be positioned at the same location or distributed at different locations (e.g., at one or more edge computing devices) and communicably coupled accordingly.

The reviews database 109 is configured to store a plurality of customer reviews for a plurality of products. In one form, the reviews database 109 may include a spreadsheet, a comma-separate valves (CSV) file, and/or a JavaScript Object Notation (JSON) file. In one example, each customer review includes data that reflects and/or expresses a customer's experience that evaluates of a specific product made on behalf of the person that has used and/or purchased the specific product. In some forms, the data includes unstructured, text word having one or more text words used to express the customer's experience with the specific product. In some form, the data further includes both text word and image data of the specific product that is associated with the respective text word. In this example, the image data is a digital image of the specific product being evaluated and reflected by the customer's experience.

The package list database 110 is configured to store a package list profile. In one form, the package list profile includes a library of packaging related word terms. Each packaging relating word is organized based on a rank of a cumulative total of a number of occurrences that particular word found in negative reviews for a specific product or customer reviews have a predetermined rating, where the predetermined rating reflecting a negative review. While the packing related words are organized based on rank, the packaging related word may be organized based on another criteria (e.g., first in or alphabetical order) without departing from the scope and spirit of the present disclosure.

The web scraping module 108 is configured to extract one or more customer reviews for a specific product from a webpage of a website 118 of the remote server associated with an e-commerce platform. In one form, the web scraping module 108 is an automated, web data scraping or web data extraction application embedded within the packaging evaluation platform. In one form, the web scraping module 108 is configured to receive a web address 120, for example a URL address, from the PE portal 102 as shown in FIG. 2. Using the web address, the web scraping module 108 is configured to send a request for connection to the website 118, via the internet connection, associated with the web address and establish a connection between the website 118 and the scraping module. The web scraping module 108 is configured to fetch the webpage associated with the web address, such as fetching the HTML code for the selected website.

In some forms, the web scraping module 108 is configured to fetch an entire website related to the web address. In one form, the web scraping module 108 is configured to extract, by parsing and locating, all of the customer reviews from text-based mark-up, such as hypertext markup language (HTM) or extensible hypertext markup language (XHTML) code. After locating the customer reviews, the scraping module is configured to extract and format all of the customer reviews. The web scraping module 108 is configured to store each customer review into the reviews database 109, as a structured data set.

In another form, for example in a training operation, the web scraping module 108 is configured to extract one or more customer reviews based on a user determined selection criteria. The user determined selection criteria may be received via the PE portal 102. In this example, the predetermined selection criteria include all customer reviews having a low rating, for example a two-star rating or below. The two-star rating is select to ensure that the customer service rating will include and focus on a high number of negative reviews. While a two-star rating is selected as a low rating, a low rating may include a higher or lower rating without departing from the spirit and scope of the present disclosure.

The data preparation module 112 is configured to identify one or more packaging related reviews from the plurality of customer reviews based on the package list profile. In one form, the packaging list profile includes a machine learning profile or a user identified list of packaging terms. In some forms, the packaging list profile is trained using a machine learning training module.

In one form, to generate the packaging list profile, the data preparation module 112 is configured to utilize or employ a Term Frequency-Inverse Document Frequency (TF-IDF) machine learning technique that is advantageous in assessing the relative value of words in the text. In one form, the TF-IDF algorithm includes two metrics that are multiplied: the number of times a word appears in a document, called Term frequency (TF), and the word's inverse document frequency across a group of documents, called Inverse document frequency (IDF). First, the TF computation method determines a word's frequency is the number of times it appears in a document. Using IDF method, the frequency is then adjusted based on the document's length. By computing the logarithm of the total number of documents divided by the number of documents containing a keyword, the inverse frequency of a word is determined. So TF-IDF is calculated via Eq. (1):

TF−IDF=TF×IDF (1)

Where TF and IDF are calculated by following formulas:

$$T F = \frac{{f}_{i}}{{f}_{r}} \qquad ( 1 )$$

Where fᵢ is the number of times the term “i” appears in a review, fᵣ is the total number of terms in every review:

$$IDF = Log ( \frac{N}{{N}_{i}} ) \qquad ( 2 )$$

Where N is the total number of reviews Nᵢ is the number of reviews, including the term “i”.

In one form, the data preparation module 112 is configured to rank one or more of the package related words of within the package list profile in order from highest occurrence to lowest occurrence. Any term identified to have a frequency number above a predetermined threshold can be used to generate the package list profile. In another form, a user, via the PE portal, selects the one or more ranked packaging related words and modify, such as adding or subtracting, them within the package list profile. The data preparation module 112 is configured to store into the package list profile within the package list database 110.

Using the package list profile, the data preparation module 112 is configured to reduce a number of customer reviews to a number of packaging related reviews. For example, using tokenization process, the data preparation module 112 is configured to split each sentence, phrase, paragraph of each customer review into one or more text words, for example, a single text word or multiple text words, such a phrase. Each text word or phase is identified as a token.

The data preparation module 112 is configured to reduce, using a lemmatization process, each token into its base form or root form. In general, the lemmatization process refers to morphological analysis of words, that aims to reduce inflectional forms and sometimes derivationally related forms of a word to a common base form, which is known as the lemma. Lemmatization is important when we have different forms of a word rather than only its basic form. For instance, if we have ‘get, got and gotten’ instead of just having ‘get’.

With each customer review is broken down into a text word or a plurality of text words in their base form, the data preparation module 112 is configured to identify one or more package related reviews from the plurality of tokens, or text words, associated with the customer reviews based on the packaging list profile.

In some forms, the sentiment module 114 is configured to determining whether each of the one or more packaging related review is a negative review or a positive review based a sentiment model. In one form, the sentiment model includes a machine learning model that categorizes one or more text words as a positive review or a negative review. In one form, the sentiment module 114 further determines whether a package related review is neutral. In some forms, the sentiment model is configured to a natural language process such as a sentiment analysis (SA) process. In one form, the SA process includes a classifier that is a machine learning model to find variable items based on convinced features.

In one form, the classifier is a Long Short-Term memory (LSTM) classifier, a Lexicon-based classifier, or Naïve Bayes (NB) classifier. In one form, LSTM is an artificial neural network-based model that uses character and word-level embedding to determine whether a given text is “positive” or “negative.” In another form, the lexicon-based model is configured to assign a score to words based on their emotional connotations, such as positive or negative. The scores are then summed up to calculate an overall sentiment of the text. In some forms, Naïve Bayes is a “probabilistic classifier” based on Bayes theorem to calculate probability of a text being positive or negative based on the occurrence of specific words in text. Bayes theorem is one of the most famous probability theorems and can be shown as follows:

$$P ( A \vert B ) = \frac{P ( B \vert A ) P ( A )}{P ( B )} \qquad Eq . ( 4 )$$

where the probability of A happening if B has occurred can be calculated based on the probability of occurrence of B and A and occurrence of B if A has occurred. Naïve Bayes classifier includes an algorithm that uses a matrix of features (X) instead of using the probability of a single feature such as A. In addition, instead of using an output (B), it uses a vector of response (y). Naïve Bayes also has two important assumptions are independency and equality of the probability of the features. Therefore, the Naïve Bayes equation that is shown below means y is a class variable and X is its dependent vector of features (a row from feature matrix):

$$P ( y \vert X ) = \frac{P ( X \vert y ) P ( y )}{P ( X )} \qquad Eq . ( 5 )$$

Now, we can show X as follows,

X=(x₁,x₂,x₃, . . . xₙ) Eq. (6)

and due to assumption of independency:

P(X)=P(x₁)P(x₂)P(x₃) . . . P(xₙ) Eq. (7)

The probability is calculated by:

P(y|X)=P(x₁|y)P(x₂|y)P(x₃|y) . . . P(xₙ|y)P(y) Eq.(8)

In one form, the classifier algorithm is configured as follows: first, a training data set containing a certain number of tagged reviews has been produced. This data set has reviews that are tagged as positive or negative. Now, for a new un-tagged sentence “The package was damaged,” the question is, which tag does the sentence belong to? To answer this question, the probability that the sentence “The package was damaged” is Negative and the probability that it's Positive should be calculated. Then, the largest one is the correct tag. Written mathematically, one should find the P (Negative|The package was damaged)−the probability that the tag of a sentence is Negative given that the sentence is “The package was damaged”.

The next step is deciding what to use as features. Features are the pieces of information that the algorithm takes from a text to categorize the text as a negative review or a positive review. Naïve Bayes uses word frequencies as features. In one form, the sentiment module is configured to ignore sentence construction and word order, treating every document, such as each customer review, as text words that the negative review includes. The features will be the counts of each of these words.

After determining a word frequency for each of the customer reviews, the sentiment module is configured to calculate the probability of each word of the sentence, as shown in Eq. 9.

P(“The package was damaged”)=P(The)P(package)P(was)P(damaged) Eq. (9)

To find the probability, the data set that contains the list of words with classification of the word's sentiment would help us. Therefore, the sentiment model can train based on it. Then, the probability of sentences in negative and positive classifier can be calculated by using Equations 10 and 11.

P(The package was damaged|negative)=P(The|negative)*P(package|negative)*P(was|negative)*P(damaged|negative) Eq. (10)

P(The package was damaged|positive)=P(The|positive)*P(package|positive)*P(was|positive)*P(damaged|positive) Eq. (11)

To put it in simple terms, to calculate the first term on the right-hand side of Eq. 11, the algorithm counts the frequency of the word “The” in negative reviews divided by the total number of the words available in negative reviews. After calculating for all the words, the sentiment module 114 is configured to calculate the probability of the text words being negative or positive. The higher value between these two equations defines the sentiment of the sentence. In other words, the sentiment module 114 is configured to determine whether the probability of the text words being negative is above a predetermined threshold. In one form, if the probability of each of the text words is above the predetermined threshold, the sentiment module is configured to categorize that text word as a negative review. On the other hand, if the probability of the text word is below the predetermined threshold, the sentiment module 114 is configured to categorize the text words as a positive review. Once the text words have been categorized, the sentiment module 114 is configured separately store the negative reviews and positive reviews into respective databases of the same or different datastores. Utilizing the negative reviews, the sentiment module 114 is configured to identify a plurality of negative reviews ranked having a highest number of occurrences and one or more relationships between the plurality of negative reviews.

In one form, the sentiment module 114 is configured to determine a customer identified-problem based a relationship between two frequently occurring text words found within the plurality of negative reviews categorized. The two text words includes a first text word describing a package feature and a second text word that co-occurs in association with the first text word. In other words, the sentiment module 114 is configured to identify one or more packaging features, for example that causes a customer's dissatisfaction and provide context of packaging feature. For example, 20 negative review may include “cap is broken.” If “cap” is identified as one of the most frequently occurring text words, then the sentiment module 114 could not only identify the term “cap”, but the sentiment module 114 may also identify that the term “broken” is frequently associated with the term “cap.” By identifying this relationship between frequently occurring terms (e.g. issues of a customer's dissatisfaction, but also provides some context of what is problem is being caused by the negative review, the sentiment module 114 can determine one or more customer-identified problems based on the identified relationship between frequently occurring text words. In doing so, the sentiment module 114 is configured to identify a list of frequently occurring packaging features used in the plurality of negative reviews. In some forms, the list of frequently occurring packaging features include one or more of the most frequently occurred words in a total number of the negative reviews. Using the list of frequently occurring packaging features, the sentiment module 114 is configured to identify one or more relationships between.

In some form, the sentiment module 114 is configured to use association rule mining to identify where the most frequent customer-identified problems with a package and one or more relationships between the frequently identified text words of the negative reviews.

In one form, the association rule mining is an unsupervised automated learning model that uses rules to identify the relationship or dependencies between two data items, for example words. The association rule has two parts: an antecedent (if) and a consequent (then). For example, a negative review may include “the cap was torn.” Using the association rule, “cap” is the antecedent and “torn” is the consequent. These rules are represented by the form X→Y, where X is an item or itemset that indicates the antecedent and Y is an item or itemset referred to as the consequent, and are used to extract hidden relationships between items that frequently co-occur in the database. Support and confidence parameters are commonly used to assess the validity of an association. Support parameters indicate how frequently the if/then relationship appears in the total number negative reviews. The confidence parameters indicate a number of times these relationships have been found or identified. For example, the association rule mining may include an Apriori algorithm, a FP-growth algorithm, an Equivalence Class Transformation (ECLAT) algorithm, or the like. In one form, the association rule mining is the FP-Growth algorithm that identifies the relationship between frequent occurring text words of negative reviews, with a minimum value for support and confidence parameters defined through a pruning process. The pruning process is configured to reduce the number of identified relationship that are deemed insignificant.

In one form, the association rule mining includes association rules constructed by looking for common if-then patterns in the negative reviews and utilizes a support and confidence criterion to identify the most frequent associations. The support and confidence criterion incudes a support parameter and a confidence parameter used to assess a validity of the association rules. In one form, support is defined as the rule holds with support sup in T (the transaction data set) if sup % of transactions contain X→Y. Support sup is calculated using Eq.

$$Sup = Probability ( X \to Y ) = \frac{No . of Transaction s with X ⋃ Y}{Total no . of transactions} \qquad Eq . ( 12 )$$

Confidence is shown as Conf(X→Y). An association rule X→Y is a pattern that states when X occurs, Y occurs with a certain probability called Confidence. The rule holds in T with confidence conf if conf % of transactions that contain X also contain Y. It is calculated by Eq. (13):

$$Conf ( X \to Y ) = Probability ( X ⋃ Y ) = \frac{Sup X ⋃ Y}{Sup X} \qquad Eq . ( 13 )$$

Utilizing Confidence in association rule mining is an effective way to raise awareness of data relationships.

The evaluation module 116 is configured to determine whether a package meets a predetermined assurance level based on a failure rate associated with the negative reviews for the specific product. An assurance level can included a predetermined failure rate percentage threshold or range set by a user to determine whether the failure rate or the percentage of failure rate associate with a product's package is within a predetermined acceptable threshold or range to meet one or more packaging standards. In order to determine whether the package meets the assurance level, the evaluation module 116 is configured to calculate the percent of failure rate (see Eq. 14) from at least one of the number of negative reviews or positive reviews.

$$Percent of Failure Rate = ( \frac{Number of Negative or Positive reviews}{Total Number of reviews} ) * 100 \qquad Eq . ( 14 )$$

In some forms, the evaluation module 116 is configured to compare the assurance level to the failure rate to determine whether the specific product meets a packaging standard for the product's package. In one form, the evaluation module 116 is configured to store the failure rate and the percent of failure rate for the number of negative reviews and/or the number of positive reviews in an evaluation database 130. In some forms, the evaluation module is configured to provide one or more results of the evaluation of the package based on the assurance level, the failure rate, and/or the percentage of the failure rate.

In some forms, the evaluation database 130 is configured to store data related to one or more specific packages for one or more products over time. For a specific product, the evaluation database 130 may store one or more previously stored negative reviews, positive reviews, failure rates, percent of failure rates for negative and/or positive reviews, and the like over a period of time. In one form, the evaluation database is configured to store a number of negative reviews, a number of positive reviews, identified problems of negative reviews, and identified relationships between the problem and its description of the cause.

In one form, the EP portal 102 is further configured to retrieve the results of the evaluation of the package. In at least one form, the EP portal 102 is further configured to generate a visual representation of the results. The results could include of at least one of a number of occurrences for one or more package related words for a specific product, the one or more failure rates, a number of negative reviews, a number of positive reviews, and one or more failure rate percentages over time for one or more product designs for a specific product and/or a number of products. For example, the EP portal 102 is configured to display one or more text words found based on a frequency of occurrence words in a graphical representation, such as a word cloud, bar charts, a table chart and/or pie charts. In this example, the word cloud is configured to display the word with the highest frequency of occurrence within the customer reviews as the largest word. In another example, the word cloud is configured to display each of the negative reviews found based their frequency of occurrence within a total of the negative reviews for the specific product. In this example, a negative review that occurred with the highest frequency is displayed with the largest font size and a negative review that occurred with the least frequency is displayed with the smallest font size. In yet another example, the display module is configured to display the negative reviews and the positive reviews of the packaging reviews along with their respective failure rate percentage for one or more specific products.

In some forms, the EP portal 102 is configured to display an image related to one or more of the customer reviews to verify or visualize a specific package associated with a specific customer review.

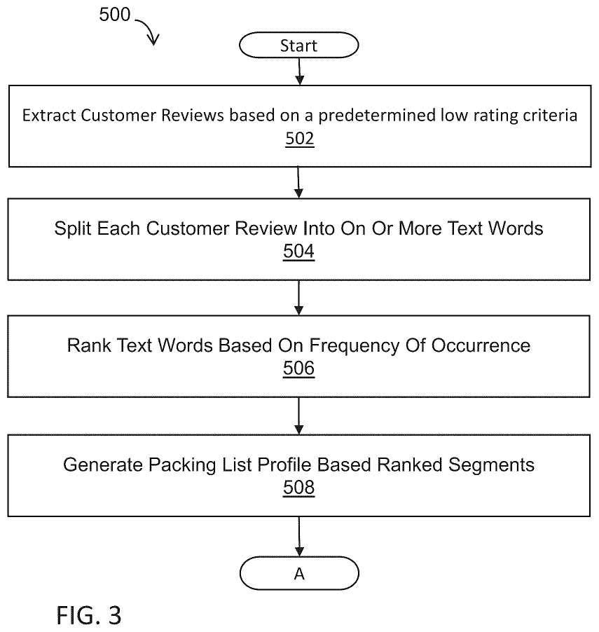

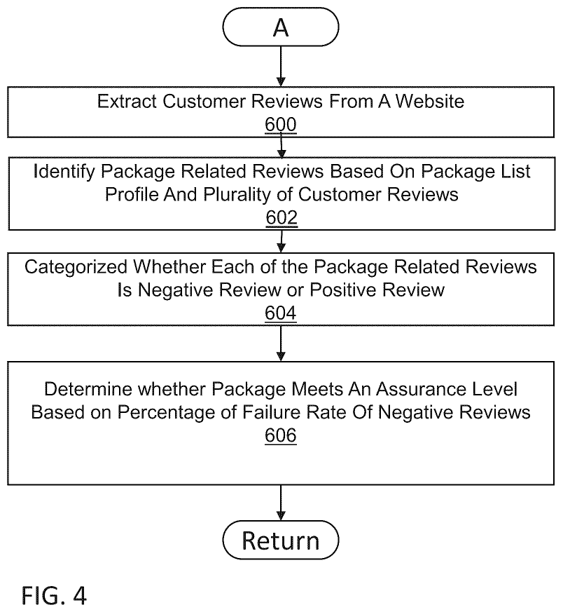

Referring to FIGS. 3-4, the following examples are provided to illustrate a method 500 to evaluate a package of a product. The method 500 includes extracting a plurality of customer reviews based on a predetermined criteria at 502. In this form, the predetermined criteria include selecting every customer review data that include a rating below two stars. Each customer review includes one or more text words and optionally image data representing a digital image of the product that is associated with the text word. The one or more text words describe a customer's experience and evaluation of the product. At 504, the method includes splitting each of the customer reviews into one or more segments. Each segment includes at least one word, a phrase including two or more words, or a sentence. In this example, the segment is a single text word. At 506, the method includes ranking the segments based on a frequency or the number of times the segment appears in the total number of customer reviews extracted. At 508, the method includes generating a packaging list profile using a TF-IDF algorithm which determines a frequency that a word appears in a document, such as the number of occurrences a word appears in a negative review and then adjusts the frequency based on the document's length or the total number of negative reviews.

At 600, the method includes extracts all of the customer reviews related to the product, using a user-identified web address, such as a URL address. At 602, the method identifies one or more packaging related reviews based on a packaging list profile and the customer reviews extracted. At 604, the method includes predicting whether each package related review is a negative review or a positive review and determines failure rate for the negative review. At 606, the method includes determining whether the package of the product meets a predetermined assurance level criteria. In one form, the predetermined assurance level criteria include a predetermined threshold or range. If the failure rate is lower than the assurance level, the package is acceptable without any major design change. On the other hand, if the failure rate is above the assurance level, the package for the product may need to be redesigned. The method includes determining a frequency of a relationships between two or more words of the negative review to identify one or more packaging issues. The method includes displaying, using a user interface device, a word cloud of one or more text words based on failure rate, a frequency of words in the negative reviews.

It should be readily understood that the method 500 is just an example, and other methods may be implemented.

The following case studies are provided as examples implementing the systems and method disclosed herein.

### EXAMPLE 1

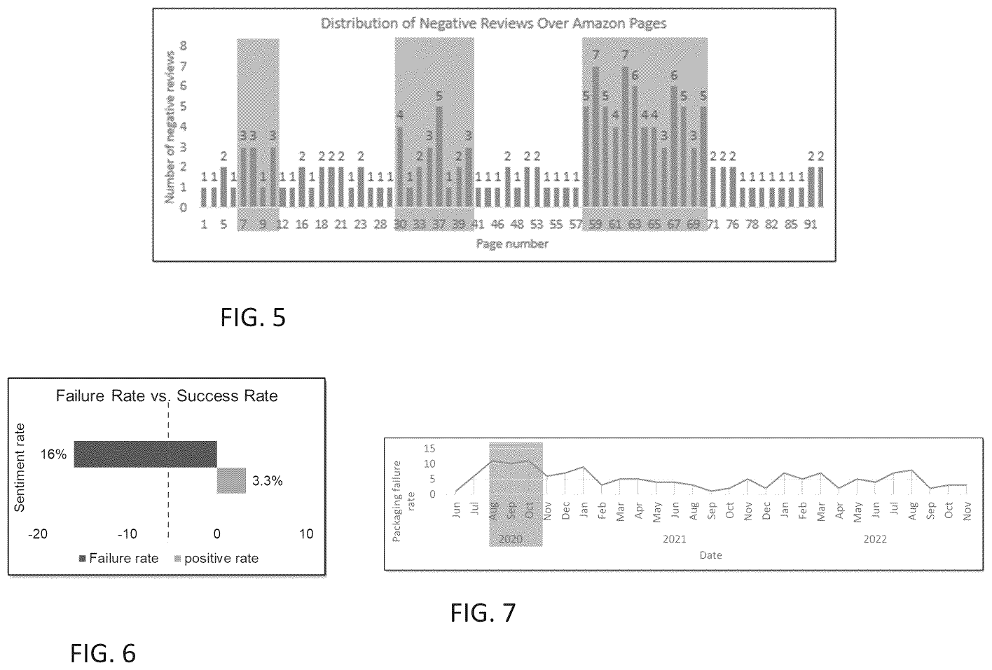

In this example, if there are more than ten reviews on an e-commerce platform, they may be listed on separate pages. This case study has over 922 reviews and it has 93 pages of reviews. The system's 100 result for the case study highlights the necessity of reading every review, as shown in FIG. 5.

A result of the sentiment analysis in the web-based intelligent packaging evaluation model is shown in Error! Reference source not found.-A. The failure rate helps designers rethink the packaging features, and if it is above their assurance level in manufacturing, they should redesign the package and address its problems. However, if the failure rate is lower than the assurance level, it would be acceptable without major design changes. For a more accurate failure rate, we should consider all of the purchases which were not available on e-commerce platform. For example, FIG. 7 displays the monthly failure rate for 2020, 2021, and 2022, indicating higher failure rates in August 2020 and October 2020, and providing valuable insights for designers to analyze and address packaging issues.

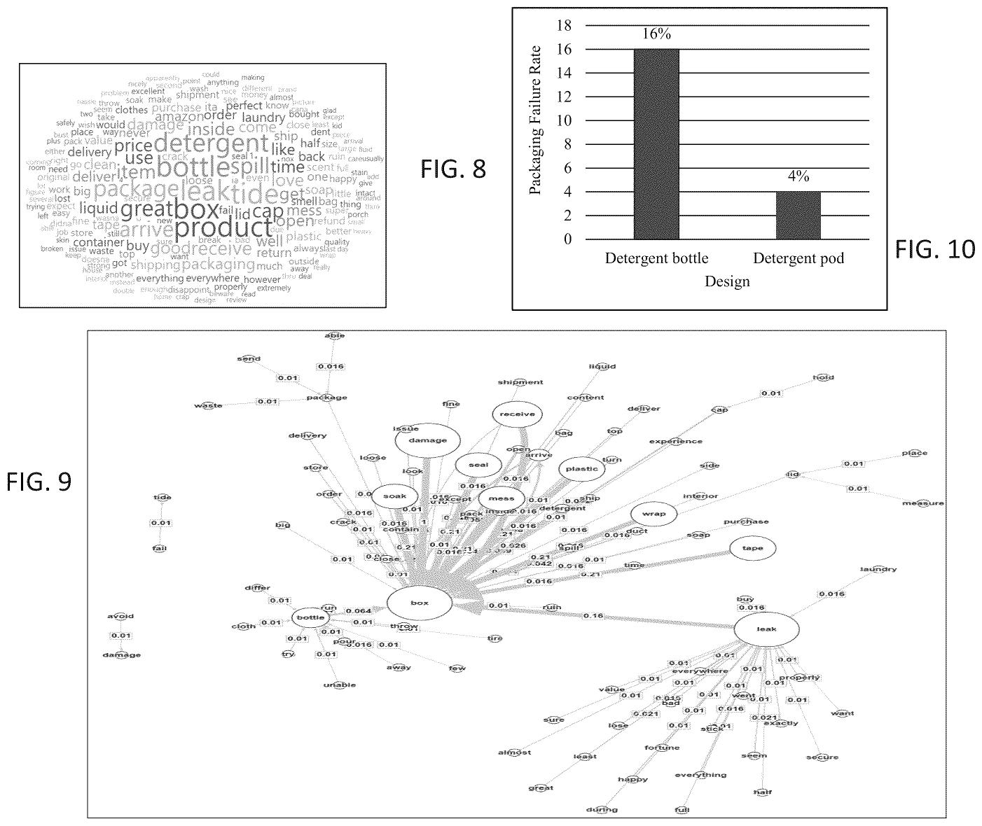

FIG. 6 displays failure rates and package positive rates. FIG. 7 displays failure rate over time. These results show that there should be some problems with the box, bottle, cap, and package, as shown in FIG. 8. But what are the relationships between these problems? Which parts of the package/product got damaged? The Fp-growth association rule mining algorithm with specific minimum support and confidence (0.01 and 0.01) values was applied to negative sentences to answer these questions.

From the negative parts identification aspect, a user interface displays a graph showing which words are connected to packaging word lists (directed edges' weight show support value and vertices are frequent words in reviews. Directed edges between words show an association between rules between ancestors and consequences. If the edges are thicker, there are strict rules between frequent item sets. For example, rules between the box and other frequent words are shown in Table 1 (these words are ordered based on their frequencies). Therefore, the main concern of the box is leakage. So, it can be concluded that there are some serious design problems associated with the detergent liquid that, if improved, would satisfy more customers. All these leak-causing factors can affect the efficient containment of the product. After identifying these factors, we can conclude that the package would result in containment failure. Hence, leak testing should be redesigned at the development stage, focusing on specific components like the bottle, cap, wrapping, and tape.

TABLE 1
Meaningful association rules for consequent of “box”

| Antecedent | Consequent | Support | Antecedent | Consequent | Support |
|---|---|---|---|---|---|
| leak | box | 0.16 | cap | box | 0.042 |
| inside | box | 0.061 | wrap | box | 0.021 |
| spill | box | 0.064 | soak | box | 0.021 |
| bottle | box | 0.064 | seal | box | 0.021 |
| open | box | 0.058 | mess | box | 0.021 |
| arrive | box | 0.048 | plastic | box | 0.021 |
| box | arrive | 0.048 | tape | box | 0.021 |
| duct | box | 0.042 | | | |

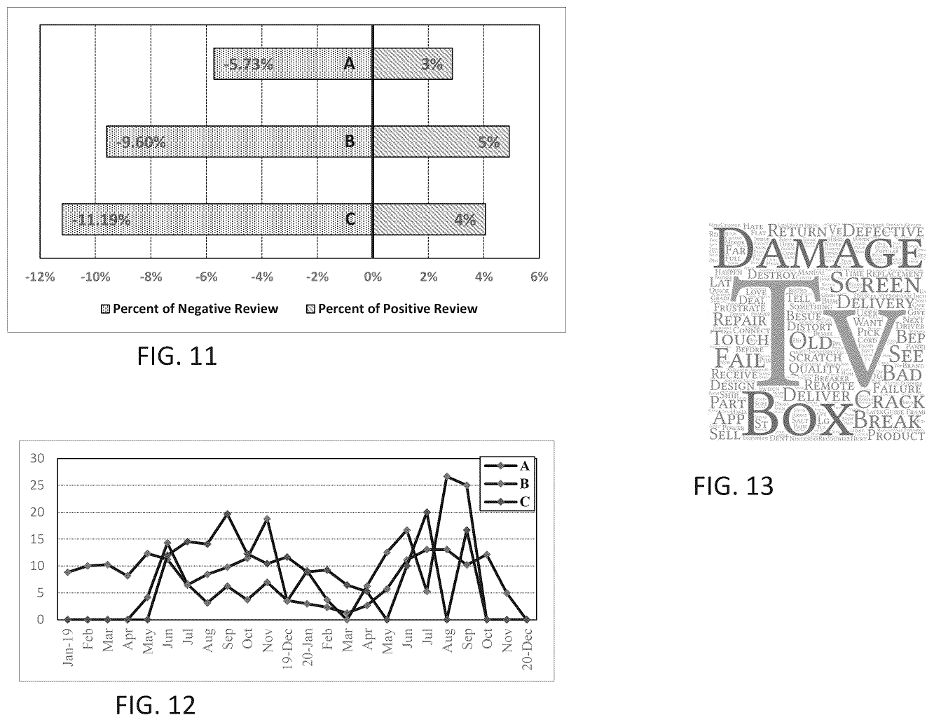

FIG. 11 provides a graphical illustration having relationships between words based on support value; edges' weight shows support value, and vertices are frequent words in reviews.

### EXAMPLE 2

### Packet Laundry Detergent Soap

The second design is a detergent packet. It got an 88% 5-star rating and includes 81 packets. Its number of reviews is 5,650, with 91,706 total ratings. Both products have free shipping on orders over $25.00 shipped by an e-commerce platform.

In one form, the system 100 for evaluating a package for a product showed that the liquid detergent bottle had a failure rate of 16%, while the detergent pod had the lowest rate at 4%, indicating better performance in protection, containment, and convenience functions. FIG. 12 provides a bar chart that compares failure rates of different designs for the same product with 10% assurance level. Therefore, the liquid detergent bottle's design needs to be reconsidered since its failure rate matches the assurance level.

The results of the associate rule mining yielded several findings related to the detergent pod, including concerns regarding the pod itself, its package, box, leakage, lid, bottle, and cap. Among the association rules generated, two rules were related to the cap: “child→cap” and “lock→cap,” as illustrated in FIG. 12.

FIG. 12 has shown that the most frequent items mentioned in reviews were lock caps and child-resistance concerns. We correlated images of those reviews, including frequent item sets, to obtain further details about this problem. FIG. 12 also demonstrates a change related to the child-proof cap. Although this change improved child resistance, it made opening the cap difficult for adults. Therefore, the designers reconsidered the cap design to satisfy both adults and prevent the child from opening it. Consequently, the previous design showed convenience failure because, based on the convenience function of the package, the pack should have been picked up, opened, and unpacked without potential damage to the content and consumer.

### Example 3

### TVs

In this example, TVs are chosen as the product example. TVs are in high demand and suffer from many packaging issues such as delivery with fractured screens. Three famous TV brands with similar price and size were used for study.

First, the packaging list profile includes one or more text words related to TVs and their respective frequencies as shown in Table 2. Also, four words were added to the list, which are related to the packaging of TVs, using a user interface device. At the end, package identification profile includes a plurality of text words, such as break, damage, crack, deliver, delivery, destroy, fail, failure, defect, defective, distort, scratch, protect and shatter.

TABLE 2
Frequency of packaging words in 1-and 2-star
reviews for 3 TV brands

| Words | Frequency | Words | Frequency |
|---|---|---|---|
| Defect | 54 | Deliver | 29 |
| Damage | 41 | Fail | 20 |
| Break | 40 | Shatter | 12 |
| Delivery | 40 | Protect | 8 |
| Crack | 36 | Scratch | 7 |

The results can be categorized into three distinct sections: failure rate, tracking failure rate over time, and word clouds. FIG. 2 compares the failure rate of TVs from different brands (A, B and C). From this figure, one can extract very valuable information for designers. For instance, for marketing purposes one can compare failure rates between different brands. More importantly, the assurance level can check in the actual real-world environment what designers measured during their standard tests. For every new product, packaging engineers set an assurance level by doing a series of standard physical tests to determine the failure rate of the designed package. By comparing the assurance level with failure rate, we can make sure that the product meets all the requirements and if it does not match, modify the assurance level. Also, comparing failure rates shows which TVs packaging has last damage during online shopping. For example, in FIG. 13, TV C has the highest number of negative reviews compared with TV B and TV A. Therefore, TV C has packaging problems during online shopping.

FIG. 13 provides a graphical representation of a failure rate in 2019 and 2020 for a product in different brands.

FIG. 14 provides a graph tracks the failure rate over time and shows the percent of negative reviews in different months and years for the three TV brands. Analysis of this chart shows that during May through October, all TVs had high peaks of negative reviews in 2019 and 2020. Also, the percent of negative reviews for all three TV brands were higher in 2020 than in 2019. Perhaps the packaging designers changed the cushion of the product or the way of distribution in 2020; if so, the new ones did not work very well. These are items that packaging designer could check based on this chart.

The word cloud is a method for data visualization, and shows a “cloud” that contains many words in different sizes. The largest word is the one with the highest frequency in data. FIG. 4 depicts word clouds for negative sentences for the TV brands. These word clouds show which part of the package has the highest possibility of problems. As can be seen, the words such as screen, damage, defect, crack, and break have the highest frequency. From the word cloud, a user can identify the cause of the problems. The frequency of related words for one of the TV brands is shown in FIG. 13.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, the term “module” may refer to, be part of, or include; an Application Specific Integrated Circuit (ASIC); a digital; analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium, The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method of evaluating a package durability, the method comprising:
extracting, using a package evaluation system, a plurality of customer reviews for a specific product from a user-identified website, wherein each customer review includes data that is used to express a customer's experience with the specific product;
identifying, using the package evaluation system, one or more packaging related reviews based on a packaging list profile and the plurality of customer reviews;
categorizing, using the package evaluation system, whether each of the one or more packaging related reviews is a negative review or a positive review;
determining, using the package evaluation system, whether the package meets an assurance level based on a percentage of failure rate associated with a plurality of negative reviews categorized, wherein the assurance level indicates whether the package provides an acceptable level of performance; and
providing one or more results of an evaluation of the package based on the assurance level and the percentage of failure rate.

2. The method of claim 1, wherein the identifying, using the package evaluation system, the one or more packaging reviews comprises:
splitting, using a tokenization process of the packing evaluation system, each customer review of the plurality of customer reviews into one or more segments of text words, wherein the one or more segments of text words includes an individual word or a phrase having two or more words;
determining, using a lemmatization process of the packaging evaluation system, a base form of each word in the one or more segments of text words; and
identifying, using the package evaluation system, one or more packaging related reviews based on a packaging list profile and the one or more segment of text words.

3. The method of claim 1, wherein the categorizing, using the package evaluation system, whether reach of the one or more packaging related reviews as a negative review or a positive review further classify the one or more package related reviews as the positive review or the negative review based a sentiment model, wherein the sentiment model is a machine learning model using natural language processing.

4. The method of claim 1, wherein the extracting, using the package evaluation system, the one or more customer reviews further comprises retrieving the one or more customer reviews using a web scrapper of the package evaluation system.

5. The method of claim 1, wherein the one or more customer reviews comprises one or more text words describing the customer experience with the specific product and one or more customer uploaded images associated with the one or more text words.

6. The method of claim 1, further comprising:
identifying, using the packaging evaluation system, a number of negative reviews;
identifying, using the packaging evaluation system, a number of positive reviews;
determining, using the packaging evaluation system, a percentage of failure rate for the negative reviews based on a total number of package related reviews; and
displaying a graphical image of the percentage of failure rate for the negative reviews.

7. The method of claim 1, further comprising:
extracting, using the package evaluation system using an embedded web scraper, the customer reviews from the website for the specific product based on a predetermined rating criteria;
splitting, using a tokenization process of the packing evaluation system, each customer review into one or more text words, wherein the one or more text words includes an individual word or a phrase having two or more words;
ranking the one or more text words based on a frequency of occurrence; and
generating the packing list profile based on one or more ranked words, wherein the packing list profile is a library of words related to packaging.

8. The method of claim 7, wherein the predetermined rating criteria includes one or more customer reviews at or below a predetermined low negative rating.

9. The method of claim 7, further comprising receiving, using the packaging evaluation system, one or more packaging related terms from user interface device to modify the packing list profile.

10. The method of claim 1, further comprising:
determining that the package is acceptable, if the failure rate is lower than the assurance level;
determining that the package is unacceptable, if the failure rate is above the assurance level, the package for the product may need to be redesigned; and
providing an indicator providing whether the failure rate meets the assurance level.

11. The method of claim 1, further comprising identifying, using the packaging evaluation system, a customer identified-problem based a relationship between two frequently occurring text words found within the plurality of negative reviews categorized, wherein the two text words includes a first text word describing a package feature and a second text word that co-occurs in association with the first text word.

12. The method of claim 11, wherein identifying, using the packaging evaluation system, one or more customer identified-problems associated with the package comprises:
identifying a list of frequently occurring text words used within the plurality of negative reviews categorized, wherein at least one text word of the list of frequently occurring text words identifies a packaging feature;
identifying one or more relationships between a first text word of the list of frequently occurring list of text words and another frequently occurring text word of the list of text words associated with the first text word; and
determining the one or more customer identified-problems based on the one or more identified relationships.

13. The method of claim 12, further comprising determining, using the packaging evaluation system, a number of occurrences for each identified relationship between each packaging feature of the list of frequently occurring packaging features and a frequently text word associated with a respective packaging feature.

14. The method of claim 13, further comprising pruning, one or more identified relationships between each packaging feature of the list of frequently occurring packaging features and a frequently text word associated with a respective packaging feature to reduce the number of identified relations below a predetermined threshold.

15. A packaging evaluation system for a package, the packaging evaluation system comprising:
a processor;
a non-transitory computer readable medium comprising instructions that are executable by the processor, wherein the instructions comprise:
extracting a plurality of customer reviews for a specific product from a user-identified website, wherein each customer review includes one or more text words that is used to express a customer's experience with the specific product;
identifying one or more packaging related reviews based on a packaging list profile and the plurality of customer reviews;
categorizing, using a natural language process, whether each of the one or more packaging related reviews is a negative review or a positive review;
determining a customer identified-problem based a relationship between two frequently occurring text words found within the plurality of negative reviews categorized, wherein the two text words includes a first text word describing a package feature and a second text word that co-occurs in association with the first text word; and
providing one or more results of an evaluation of the package based on the customer identified problem.

16. The system of claim 15, wherein the one or more customer reviews comprises one or more text words describing the customer experience with the specific product and one or more customer uploaded images associated with the one or more text words.

17. The system of claim 15, wherein the instructions further comprise:
extracting, using an embedded web scrapper, the customer reviews from the website for the specific product based on a predetermined low rating criteria;
splitting, using a tokenization process, each customer review into one or more text words, wherein the one or more text words includes an individual word or a phrase having two or more words;
ranking the one or more text words based on a frequency of occurrence; and
generating the packing list profile based on one or more ranked text words, wherein the packing list profile is a library of words related to packaging.

18. The system of claim 15, wherein identifying one or more customer identified-problems associated with the package comprises:
identifying a list of frequently occurring text words used within a plurality of negative reviews categorized, wherein at least one text word of the list of frequently occurring text words identifies a packaging feature;
identifying one or more relationships between a first text word of the list of frequently occurring list of text words and another frequently occurring text word of the list of text words associated with the first text word; and
determining the one or more customer identified-problems based on the one or more identified relationships.

19. The system of claim 15, wherein the instructions further comprise determining a number of occurrences for each identified relationship between each packaging feature of the list of frequently occurring packaging features and a frequently text word associated with a respective packaging feature.

20. The system of claim 15, wherein the instructions further comprise pruning, one or more identified relationships between each packaging feature of the list of frequently occurring packaging features and a frequently text word associated with a respective packaging feature to reduce a number of identified relationships based on a predetermined threshold.

21. A method comprising:
scraping a plurality of customer reviews for a specific product from a user-identified website, wherein each customer review includes one or more text words that is used to express a customer's experience with the specific product;
identifying one or more packaging related reviews based on a packaging list profile and the plurality of customer reviews;
categorizing, using a natural language process, whether each of the one or more packaging related reviews is a negative review or a positive review;
identifying a customer identified-problem based a relationship between two frequently occurring text words found within the plurality of negative reviews categorized, wherein the two text words includes a first text word describing a package feature and a second text word that co-occurs in association with the first text word; and
providing one or more results of an evaluation of the package based on the customer identified problem.
